(19) United States
(12) Patent Application Publication
(10) Pub. No.: US 2020/0184238 A1
(43) Pub. Date: Jun. 11, 2020

(54) VEHICLE OCCUPANT MONITORING SYSTEM USE CASES

(71) Applicant: Panasonic Automotive System Company of America, Division of Corporation of North America, PEACHTREE CITY, GA (US)

(72) Inventors: SACHIKO KOBAYASHI, NOVI, MI (US); PATRICK HANSLITS, CLARKSTON, MI (US); MARTIN EZEQUIEL NESPOLO, GROSSE POINTE WOODS, MI (US); ANDREW JOSEPH BIANCHI, PLEASANT RIDGE, MI (US)

(73) Assignee: Panasonic Automotive System Company of America, Division of Corporation of North America (8 pp.)

(21) Appl. No.: 15/782,242

(22) Filed: Oct. 12, 2017

Related U.S. Application Data
(60) Provisional application No. 62/409,043, filed on Oct. 17, 2016.

(51) Int. Cl. G06K 9/00; G06T 7/70; B60Q 5/00; B60R 1/062; B60R 11/04; B60R 1/00; B60R 11/02

(52) U.S. Cl. CPC G06K 9/00845; G06T 7/70; G06K 9/00228; B60Q 5/005; B60R 1/062; B60R 2300/205; B60R 1/007; B60R 11/0235; G06T 2207/30201; G06T 2207/20081; B60R 11/04

(57) ABSTRACT

A motor vehicle includes a loudspeaker disposed within a passenger compartment of the vehicle approximately between an occupant's seat of the vehicle and a space of interest disposed outside of the vehicle. A camera is positioned to capture images of a face of an occupant of the vehicle. A processing device receives the images captured by the camera, and determines from the images that the occupant is not looking at the space of interest disposed outside of the passenger compartment. In response to the determining that the driver is not looking at the space of interest disposed outside of the passenger compartment, the processing device causes a sound to be emitted from the loudspeaker.

### CROSS-REFERENCED TO RELATED APPLICATIONS

This application claims benefit of U.S. Provisional Application No. 62/409,043 filed on Oct. 17, 2016, which the disclosure of which is hereby incorporated by reference in its entirety for all purposes.

### FIELD OF THE INVENTION

The disclosure relates to the field of monitoring systems, and, more particularly, to occupant monitoring systems in motor vehicles.

### BACKGROUND OF THE INVENTION

Currently, there are some driver monitoring systems that monitor the driver via steering wheel sensors, seat sensors, thermo sensors, etc., for purposes of authentication.

### SUMMARY

The present invention may encompass the unique use cases described below for a vehicle occupant monitoring system (VOMS) that helps occupants with ergonomics, attention management and wellness management. In-vehicle cameras may detect the position of the occupant's eyes and the direction in which the occupant is looking in many of these embodiments.

### Ergonomic Enhancement

Active Head Up Display (HUD)—The position of the occupant's eyebox is determined based on positions of the occupant's eyes. The position or orientation of the HUD mirror may be automatically adjusted depending upon the position of the occupant's eyebox in order to position the virtual image within the occupant's view.

Side-View Mirrors—Controls and the angles of the side-view mirrors may be automatically adjusted so that they are positioned for good visibility based on the positions of the occupant's eyes.

Intelligent Headlamps Enhancement—The angles of the vehicle headlamps may be automatically adjusted based on the direction in which the occupant is looking in order to shift additional light in the direction in which the occupant is looking. At low speeds, side lamps may be automatically turned on and the angles of the side lamps may be automatically adjusted in order to illuminate posted street addresses. Laterally directed cameras and character recognition software may be used to detect the presence of posted street addresses.

Nighttime Display Dimming—At night, or when it is dark, as determined by an ambient light sensor, the center stack display automatically dims in response to determining that the occupant is not looking at the center stack display.

Occupant Detection—The identity of the occupant may be determined via facial recognition software or via recognition of eye characteristics. Depending upon the occupant's gender and age, approximation changes may be automatically made to the vehicle display's font size, user interface (UI) mode, the screen brightness, etc.

### Attention Management

Attention Cueing—The direction in which the occupant is looking may be determined via cameras. If a condition is detected that calls for the occupant's attention, the occupant's attention can be drawn to the condition by use of directional audio chimes. For example, the occupant's attention can be drawn in the direction of a blind spot. Attracting the occupant's attention in a certain direction may tie in with an enhanced audio landscape. For example, the occupant's head/eye position may cause the blind spot monitoring (BSM) warning to be triggered differently than it would be triggered in the absence of head/eye position data.

Distracted Departure—If it is detected that the occupant's eyes are not directed in the forward direction as the traffic light turns green, the inventive system triggers an audio cue to notify the occupant that the light has turned green and that it is time to accelerate.

Occupant Habit Awareness—Occupant habits may be observed and recorded, and statistics may be calculated and presented to the occupant to make him aware of his driving habits. Such statistics may include the length of time that the occupant's eyes are off the road, the number or frequency of the occupant's glances away from the road that are greater than two seconds, the length of time that the occupant looks down (e.g., at his phone), or the number or frequency of instances of the occupant looking down. The occupant may receive alerts about these instances, or there may be auditory stimuli to bring his attention back to the road and the driving task.

Pedestrian Red Carpet—A red hazard “carpet” may be light projected in front of the vehicle in a direction in which the occupant is not looking. Thus, pedestrians are shown and have notice of where the occupant is not looking across an intersection or cross walk. The pedestrian may then choose to not walk into the red hazard area. The vehicle may need to have a threshold combination of speed and closeness to the intersection or cross walk before this feature is triggered.

### Occupant Wellness Management

Drowsiness Detection—The drowsiness of the occupant may be determined based upon, for example, how far his eye lids are open, or the rate at which he blinks his eyes. If it is determined that the occupant is drowsy, then a call may be placed to the occupant's telephone, a window may be opened, or the occupant may be presented with a task in order to regain the occupant's attentiveness.

Emotion Recognition—The occupant's emotions may be determined based on facial recognition. For example, the number of smiles by the occupant within a period of time, or the percentage of time the occupant spends smiling may be determined.

Health Monitoring—The occupant's state of health may be determined though video processing of the driver's face and body. For example, the heartbeat of a human can be measured with video processing of the green channel for an RGB image sensor. In other examples the occupant monitor system may detect choking, coughing, sneezing and sweating through similar video processing methodologies. Using combinations of these informations streams, a sophisticated software algorithm may make predictions and suggest treatment for illnesses like colds, flu, intoxication, body toxins, hyperventilation, hypoventilation, apnea, choking and more. Using machine learning and video processing, an occupant's weight trends and organ failure (e.g., kidney failure) may be determined through changes in the skin color, blotchiness, droopiness and darkness. Mental health may also be monitored using the same methodologies as described above.

In one embodiment, the invention comprises a motor vehicle including a loudspeaker or array of loudspeakers disposed within a passenger compartment of the vehicle approximately between a occupant's seat of the vehicle and a space of interest disposed outside of the vehicle. A camera is positioned to capture images of a face of an occupant of the vehicle. A processing device receives the images captured by the camera, and determines from the images that the occupant is not looking at the space of interest disposed outside of the passenger compartment. In response to the determining that the occupant is not looking at the space of interest disposed outside of the passenger compartment, the processing device causes a sound to be emitted from the loudspeaker or combination of loudspeakers.

In another embodiment, the invention comprises a motor vehicle including a display screen disposed within a passenger compartment of the vehicle. A camera is positioned to capture images of a face of an occupant of the vehicle. A processing device receives the images captured by the camera, and determines based upon the images that the occupant is not looking at a visual warning that presented outside of the display screen. In response to the determining that the occupant is not looking at the visual warning, the visual warning is presented on the display screen.

In yet another embodiment, the invention comprises a motor vehicle including an occupant-actuatable control device which individually adjusts a position or orientation of each of a plurality of mirrors in response to the control device being actuated. A camera is positioned to capture images of a face of the occupant. A processing device receives the images captured by the camera, and determines from the images that the occupant is looking at one of the mirrors. In response to the control device being actuated, and in response to the determining that the occupant is looking at one of the mirrors, the position or orientation of the one mirror at which the occupant is looking is adjusted.

In a further embodiment, the invention comprises a motor vehicle including a plurality of mirrors each having an individually adjustable position or orientation. A head up display presents a virtual image to an occupant of the vehicle. The virtual image has an adjustable position. A camera is positioned to capture images of a face of the occupant. A processing device receives the images captured by the camera, and determines from the images a position of eyes of the occupant. The position or orientation of the mirrors and the position of the virtual image are adjusted based on the determined position of the eyes of the occupant.

An advantage of the occupant monitoring system of the present invention is that it may enable the vehicle to “know the occupant” and enhance the occupant's experience by providing the occupant with personalization/customization/settings such as mirror orientations. Also, the occupant monitoring system can determine what the occupant is paying attention to, and can provide a safer driving experience with enhanced attention management and wellness management.

### BRIEF DESCRIPTION OF THE DRAWINGS

A better understanding of the present invention will be had upon reference to the following description in conjunction with the accompanying drawings.

FIG. 1 is a perspective view of a passenger compartment of a motor vehicle including one embodiment of an occupant monitoring system of the present invention.

FIG. 2 is a perspective view of a passenger compartment of a motor vehicle including another embodiment of an occupant monitoring system of the present invention.

FIG. 3 is a perspective view of a passenger compartment of a motor vehicle including yet another embodiment of an occupant monitoring system of the present invention.

FIG. 4 is a perspective view of a passenger compartment of a motor vehicle including still another embodiment of an occupant monitoring system of the present invention.

FIG. 5 is a perspective view of a passenger compartment of a motor vehicle including a further embodiment of an occupant monitoring system of the present invention.

FIG. 6A is an overhead view of a passenger compartment of a motor vehicle including a still further embodiment of an occupant monitoring system of the present invention.

FIG. 6B is an overhead view of a passenger compartment of a motor vehicle including the occupant monitoring system of FIG. 6a.

FIG. 7 is a block diagram of another embodiment of an occupant monitoring system of the present invention.

### DETAILED DESCRIPTION OF THE PREFERRED EMBODIMENTS

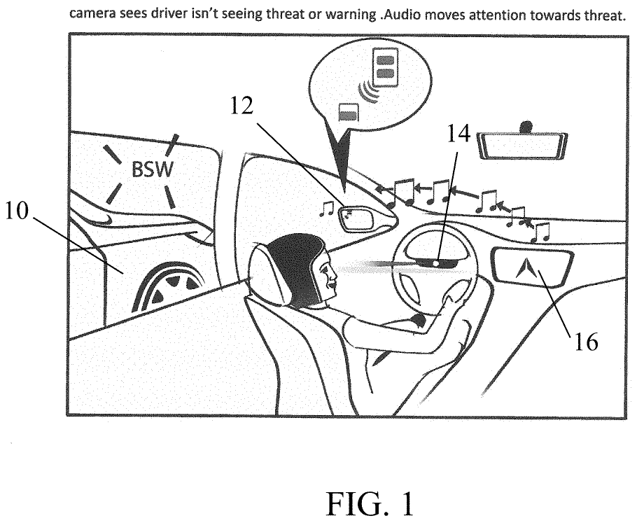

FIG. 1 illustrates one embodiment of a passenger compartment of a motor vehicle including one embodiment of an occupant monitoring system of the present invention. A blind spot warning (BSW) system detects the presence of another vehicle 10 and displays a visible warning on side view mirror 12. However, a camera 14 on the steering wheel is used to determine that the occupant is not looking at side view mirror 12 and/or has not looked at side view mirror 12 since the warning began to be displayed on side view mirror 12. Rather, the occupant monitoring system uses camera 14 to determine that the occupant is looking at a center stack display 16. In response to the determination that the occupant is not looking at side view mirror 12 and/or has not looked at side view mirror 12 since the warning began to be displayed on side view mirror 12, the occupant monitoring system causes a sound, such as a chime, to be emitted from a loudspeaker that is nearest to side view mirror 12. As a result, the sound draws the occupant's attention, and gaze, towards side view mirror 12 and he sees the warning thereon.

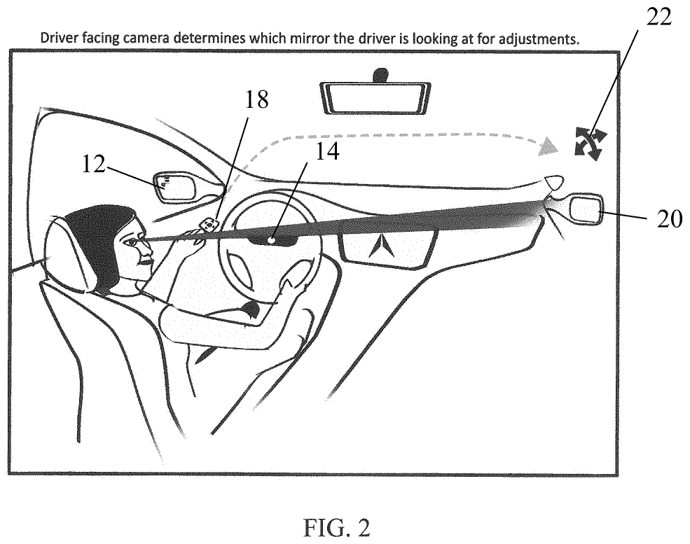

FIG. 2 illustrates a passenger compartment of a motor vehicle including another embodiment of an occupant monitoring system of the present invention. It is sensed that the occupant is pressing on a side mirror adjustment lever 18. In addition, camera 14 on the steering wheel is used to determine that the occupant is looking at passenger side view mirror 20. Accordingly, the occupant monitoring system causes passenger side view mirror 20 to be actuated in response to the occupant pressing on a side mirror adjustment lever 18, rather than occupant side view mirror 12. For example, the orientation of passenger side view mirror 20 may be changed, as indicated by double arrows 22.

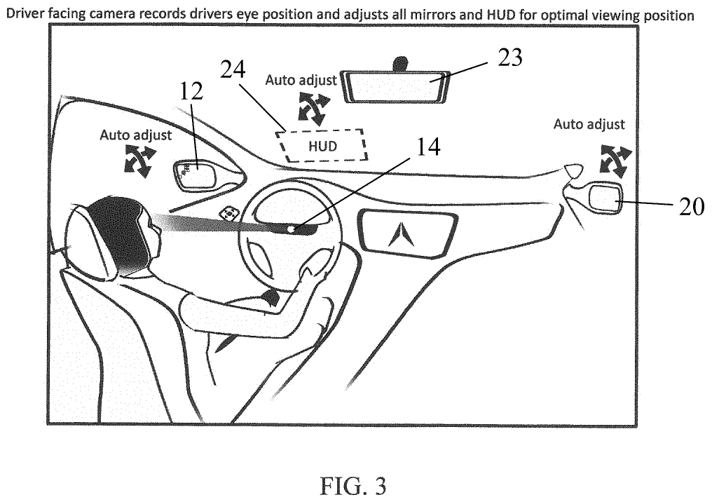

FIG. 3 illustrates a passenger compartment of a motor vehicle including yet another embodiment of an occupant monitoring system of the present invention. Camera 14 on the steering wheel is used to ascertain the position of the occupant's eyes in three-dimensional space. Based on the position of the occupant's eyes, the positions and/or orientations of side view mirrors 12, 20, a rear view mirror 23, and of a boundary 24 of a virtual image produced by a head up display may be adjusted to achieve optimal viewing positions and/or orientations. These adjustments may be performed each time an occupant sits down on the occupant's seat to compensate for that particular occupant's body characteristics. Alternatively, the adjustments may be performed continuously (e.g., at intervals of a few seconds) to compensate for movements by the occupant while he is sitting in the occupant's seat.

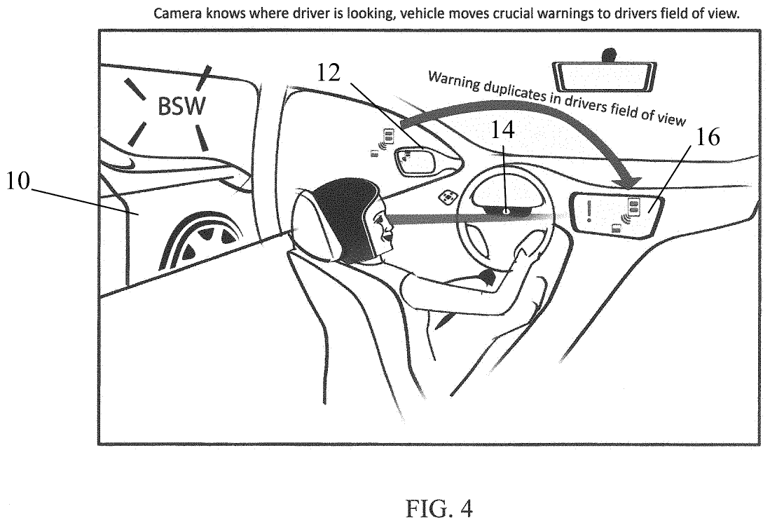

FIG. 4 illustrates a passenger compartment of a motor vehicle including still another embodiment of an occupant monitoring system of the present invention. A blind spot warning (BSW) system detects the presence of another vehicle 10 and displays a visible warning on side view mirror 12. However, a camera 14 on the steering wheel is used to determine that the occupant is not looking at side view mirror 12 and/or has not looked at side view mirror 12 since the warning began to be displayed on side view mirror 12. Rather, the occupant monitoring system uses camera 14 to determine that the occupant is looking at a center stack display 16. In response to the determination that the occupant is looking at display 16 and has not looked at side view mirror 12 since the warning began to be displayed on side view mirror 12, the occupant monitoring system causes the visible warning to be duplicated within the occupant's current field of view. That is, the visible warning on side view mirror 12 is duplicated on display 16. As a result, the occupant sees the warning on display 16.

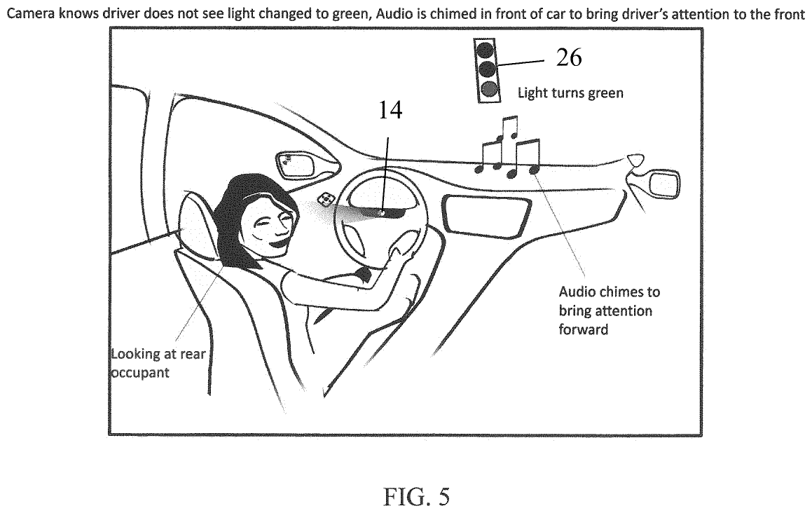

FIG. 5 illustrates a passenger compartment of a motor vehicle including still another embodiment of an occupant monitoring system of the present invention. The occupant monitoring system may draw the occupant's attention in a direction in front of the vehicle if it is detected that the occupant is not looking at the road. The occupant's attention may be drawn in a direction in front of the vehicle by a tone or beep that sounds like it is coming from a direction forward of the vehicle. In the particular embodiment of FIG. 5, a forward-facing vehicle camera may determine when a traffic light 26 turns green when the vehicle is stopped at a red light. The occupant monitoring system may detect the positions of the occupant's head and eyes and trigger an audio cue to remind the occupant to accelerate if the positions of the occupant's head and eyes indicates that the occupant's eyes are not directed forward, or that the occupant is not paying full attention to the traffic light and road. More particularly, camera 14 on the steering wheel is used to determine that the occupant is not looking in a forward direction and/or has not looked in a forward direction since traffic light 26 has turned green. Rather, the occupant monitoring system uses camera 14 to determine that the occupant is looking at the rear seat of the vehicle. In response to the determination that the occupant is not looking in a forward direction, and the occupant has not pressed on the accelerator within a threshold period of time since traffic light 26 turned green, the occupant monitoring system causes a sound, such as a chime, to be emitted from a loudspeaker that is nearest to the windshield. As a result, the sound draws the occupant's attention, and gaze, in a forward direction towards the windshield and he sees traffic light 26.

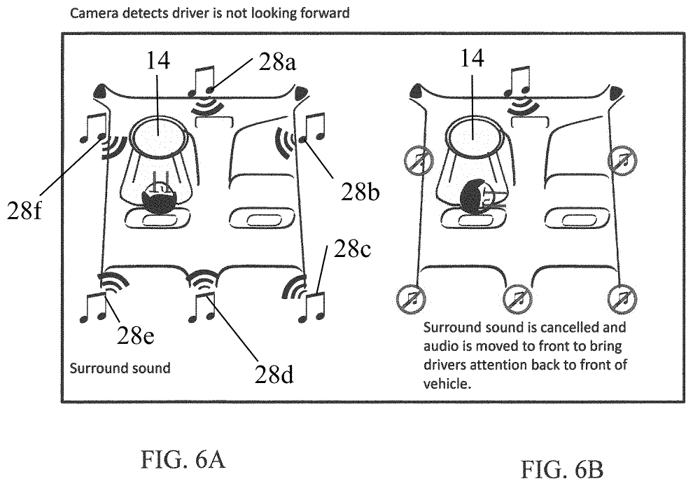

FIGS. 6A-B illustrate a passenger compartment of a motor vehicle including a still further embodiment of an occupant monitoring system of the present invention. As shown in FIG. 6A, the vehicle includes a surround sound audio system including six loudspeakers 28a-f approximately evenly spaced around a periphery of the passenger compartment. All of loudspeakers 28a-f may simultaneously emit audible sound into the passenger compartment. Camera 14 on the steering wheel is used to determine that the occupant is not looking in a forward direction, as shown in FIG. 6B, and/or has not looked in a forward direction with a threshold period of time. In response to the determination that the occupant is not looking in a forward direction and/or has not looked in a forward direction with a threshold period of time, the occupant monitoring system may cause the audio system to cease sending audio signals to loudspeakers 28b-f and send an audio signal to only loudspeaker 28a, which is closest to the windshield, or is in-between the occupant and the windshield. Thus, the occupant hears audio sound only from loudspeaker 28a in the direction of the windshield, and the occupant's attention is thereby drawn in the direction of the sound, i.e., is drawn to the windshield and to the road that the vehicle is traveling on.

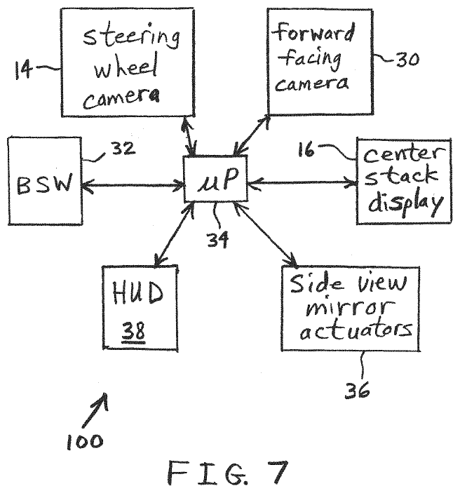

FIG. 7 illustrates another embodiment of an occupant monitoring system 100 of the present invention, including a steering wheel camera 14, a forward-facing camera 30, a blind spot warning system 32, an electronic processor 34, a center stack display 16, side view mirror actuators 36, and a head up display 38. Occupant monitoring system 100 may be suitable for use in any of the embodiments described above with reference to FIGS. 1-6.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A motor vehicle, comprising:
a loudspeaker disposed within a passenger compartment of the vehicle approximately between an occupant's seat of the vehicle and a space of interest disposed outside of the vehicle;
a camera positioned to capture images of a face of an occupant of the vehicle; and
a processing device configured to:
receive the images captured by the camera;
determine, based on the images, that the occupant is not looking at the space of interest disposed outside of the passenger compartment; and
in response to the determining that the occupant is not looking at the space of interest disposed outside of the passenger compartment, cause a sound to be emitted from the loudspeaker.

2. The motor vehicle of claim 1 further comprising an occupant's side view mirror configured to present a visible blind spot warning, the occupant's side view mirror being disposed within the space of interest.

3. The motor vehicle of claim 1 wherein the space of interest includes a portion of a road in front of the vehicle, the loudspeaker being disposed adjacent to a midpoint along a width of a windshield of the vehicle.

4. The motor vehicle of claim 1 wherein the loudspeaker comprises a first loudspeaker, the vehicle further comprising at least one other loudspeaker, the processing device being further configured to, in response to the determining that the occupant is not looking at the space of interest disposed outside of the passenger compartment, prevent any sound from being emitted from the at least one other loudspeaker.

5. The motor vehicle of claim 1 further comprising a steering wheel, the camera being mounted in the steering wheel.

6. The motor vehicle of claim 1 wherein the processing device is configured to:
determine, based on the images, that the occupant is looking in a rearward direction; and
in response to the determining that the occupant is looking in the rearward direction, cause the sound to be emitted from the loudspeaker.

7. A motor vehicle, comprising:
a display screen disposed within a passenger compartment of the vehicle;
a camera positioned to capture images of a face of an occupant of the vehicle; and
a processing device configured to:
receive the images captured by the camera;
determine based upon the images that the occupant is not looking at a visual warning that presented outside of the display screen; and
in response to the determining that the occupant is not looking at the visual warning, present the visual warning on the display screen.

8. The motor vehicle of claim 7 wherein the processing device is configured to:
determine from the images that the occupant is looking at the display screen; and
in response to the determining that the occupant is looking at the display screen, present the visual warning on the display screen.

9. The motor vehicle of claim 7 further comprising an occupant's side view mirror configured to present the visual warning.

10. The motor vehicle of claim 9 further comprising a blind spot warning system, the visual warning comprising a blind spot warning.

11. The motor vehicle of claim 7 wherein the display screen comprises a center stack display screen.

12. The motor vehicle of claim 7 wherein the camera is disposed on the steering wheel.

13. A motor vehicle, comprising:
an occupant-actuatable control device configured to individually adjust a position or orientation of each of a plurality of mirrors in response to the control device being actuated;
a camera positioned to capture images of a face of the occupant; and
a processing device configured to:
receive the images captured by the camera;
determine from the images that the occupant is looking at one of the mirrors; and
in response to the control device being actuated, and in response to the determining that the occupant is looking at one of the mirrors, adjust the position or orientation of the one mirror that the occupant is looking at.

14. The motor vehicle of claim 13 wherein the processing device is configured to:
determine from the images that the occupant is looking at a second said mirror; and
in response to the control device being actuated, and in response to the determining that the occupant is looking at the second mirror, adjust the position or orientation of the second mirror that the occupant is looking at.

15. The motor vehicle of claim 13 further comprising a steering wheel, the camera being mounted in the steering wheel.

16. The motor vehicle of claim 13 wherein the mirrors comprise an occupant's side view mirror and a passenger side mirror.

17. A motor vehicle, comprising:
a plurality of mirrors each having an individually adjustable position or orientation;
a head up display configured to present a virtual image to an occupant of the vehicle, the virtual image having an adjustable position;
a camera positioned to capture images of a face of the occupant; and
a processing device configured to:
receive the images captured by the camera;
determine from the images a position of eyes of the occupant; and
adjust the position or orientation of the mirrors and the position of the virtual image based on the determined position of the eyes of the occupant.

18. The motor vehicle of claim 17 wherein the mirrors comprise an occupant's side view mirror, a passenger side mirror, and a rear view mirror.

19. The motor vehicle of claim 17 further comprising a steering wheel, the camera being mounted in the steering wheel.

20. The motor vehicle of claim 17 further comprising an occupant-actuatable control device configured to individually adjust a position or orientation of each of the mirrors in response to the control device being actuated, the processing device being configured to:
determine from the images that the occupant is looking at one of the mirrors; and
in response to the control device being actuated while the occupant is looking at the one mirror, adjust the position or orientation of the one mirror.

21. A motor vehicle, comprising:
a camera positioned to capture images of a face of an occupant of the motor vehicle; and
a processing device configured to:
receive the images captured by the camera;
determine from the images a heartrate of the occupant;
determine from the images a state of health and wellness of the occupant;
determine from the images an emotional state of the occupant;
detect from the images an illness of the occupant; inform the occupant of the illness detected; and
recommend a treatment option through machine learning and prediction methodologies.
